(19) United States
(12) Patent Application Publication
(10) Pub. No.: US 2010/0036641 A1
(43) Pub. Date: Feb. 11, 2010

(54) System and method of estimating multi-tasking performance

(75) Inventors: Seung Won Lee, Hwaseong-si (KR); Min Soo Ryu, Seoul (KR); Byung Kwan Jung, Busan (KR)

Correspondence Address: STAAS & HALSEY LLP, SUITE 700, 1201 NEW YORK AVENUE, N.W., WASHINGTON, DC, 20005, US

(73) Assignees: Samsung Electronics Co., Ltd., Suwon-si (KR); INDUSTRY-UNIVERSITY COOPERATION FOUNDATION HANYANG UNIVERSITY, Soul (KR)

(21) Appl. No.: 12/318,043

(22) Filed: Dec. 19, 2008

(30) Foreign Application Priority Data
Aug. 6, 2008 (KR) 10-2008-0076995

(51) Int. Cl. G06F 15/00

(52) U.S. Cl. 702/186

(57) ABSTRACT

A method and system of estimating multi-tasking performance performed in multi-processor are described. The method includes dividing a plurality of tasks into a plurality of sub tasks in accordance with predefined operation types, arranging the plurality of sub tasks in accordance with a predecessor-successor structure based on the operation types of the plurality of sub tasks, and estimating multi-tasking performance of the plurality of tasks using the arranged plurality of sub tasks.

### CROSS-REFERENCE TO RELATED APPLICATIONS

This application claims the benefit of Korean Patent Application No. 10-2008-0076995, filed on Aug. 6, 2008, in the Korean Intellectual Property Office, the disclosure of which is incorporated herein by reference.

### BACKGROUND

1. Field

One or more example embodiments relate to a technique of estimating a multi-tasking performance performed by at least one processor.

2. Description of the Related Art

Multi-tasking on multiprocessors techniques is becoming important. In particular, a plurality of processors may perform multi-tasking in parallel to provide more concurrency with improved performance. A variety of devices may employ multiprocessors to improve multi-tasking performance. These devices may include mobile terminals, personal computers, set-top boxes, televisions, etc.

It is important to estimate performance of a multi-tasking system on multiprocessors. Specifically, by accurately and effectively estimating the multi-tasking performance on multiprocessors, an optimized solution may be provided to the multi-tasking system. For example, many developers may determine whether to load or run a plurality of tasks depending on the estimated multi-tasking performance.

Also, in order to accurately estimate the multi-tasking performance, a synchronization policy or scheduling policy for multiple tasks should be considered. However, multitasking systems may have a variety of synchronization policies or scheduling policies. Specifically, to develop an algorithm to estimate the multi-tasking performance based on only a single synchronization policy or a single scheduling policy is ineffective. Specifically, the algorithm may not be widely applied since operating systems may perform synchronization policies and scheduling policies different from each other, or the synchronization policies and scheduling polices may be changed depending on situations even in the same operating system.

Also, in general, a large amount of calculations and a long period of time may be required to accurately estimate the multi-tasking performance. Accordingly, there is a need to reduce the calculation amount and the period of time.

### SUMMARY

Additional aspects and/or advantages will be set forth in part in the description which follows and, in part, will be apparent from the description, or may be learned by practice of the invention.

One or more embodiments may provide a method and system of estimating multi-tasking performance which may divide a plurality of tasks into a plurality of sub tasks, and may arrange the plurality of sub tasks in accordance with a predecessor-successor structure,to effectively estimate the multi-tasking performance for a variety of synchronization policies or scheduling policies at a reduced cost in terms of calculation amount and time.

One or more embodiments may provide a method and system of estimating multi-tasking performance which may determine running-finish times based on a preempted time of other sub tasks to estimate the multi-tasking performance, thereby reducing an amount of calculations required to estimate the multi-tasking performance.

In this instance, the estimating of the multi-tasking performance may include setting running-finish times of sub tasks based on running-start times of their predecessor sub tasks and a pre-estimated required running time of each sub task; and updating the set running-finish times based on a preempted time generated due to preempting of another sub task with respect to the plurality of sub tasks.

The arranging may convert the plurality of sub tasks into a predecessor-successor structure in accordance with predefined operation types of the plurality of sub tasks.

The predefined operation types may include at least one of a computing type, a synchronization type, and a communication type, and the arranging may arrange at least two sub tasks having the communication type in accordance with the predecessor-successor structure, and also arrange at least two sub tasks having the synchronization type in accordance with the predecessor-successor structure based on a synchronization policy.

The dividing may include decomposing each of the plurality of tasks into multiple sub tasks and associating each sub task with one of the three operation types.

The method of estimating multi-tasking performance may further include determining whether the plurality of tasks are loaded or run in accordance with the estimated multi-tasking performance.

The method of estimating multi-tasking performance may further include deciding a scheduling policy and synchronization policy to run the plurality of tasks, or a resource allocation policy based on the estimated multi-tasking performance.

The foregoing and/or other aspects are achieved by providing a system of estimating multi-tasking performance, including: a task division unit dividing a plurality of tasks into a plurality of sub tasks in accordance with predefined operation types; a sub task-arrangement unit arranging the plurality of sub tasks in accordance with a predecessor-successor structure based on the operation types of the plurality of sub tasks; and a performance estimation unit estimating multi-tasking performance of the plurality of tasks using the arranged plurality of sub tasks.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates tasks according to example embodiments;

FIG. 2 illustrates an example of operation types depending on times of the tasks illustrated in FIG. 1;

FIG. 3 illustrates an example of sub tasks divided and arranged from the tasks illustrated in FIG. 1;

FIG. 4 illustrates another example of sub tasks arranged in accordance with a predecessor-successor structure of the present disclosure;

FIG. 5 is a flowchart illustrating a method of estimating multi-tasking performance according to example embodiments; and

FIG. 6 is a block diagram illustrating a system of estimating multi-tasking performance according to example embodiments, and units using results of the system.

### DETAILED DESCRIPTION OF EMBODIMENTS

Reference will now be made in detail to the embodiments which are illustrated in the accompanying drawings, wherein like reference numerals refer to the like elements throughout. Example embodiments are described below to explain the present disclosure by referring to the figures.

Hereinafter, example embodiments will be described in detail with reference to drawings.

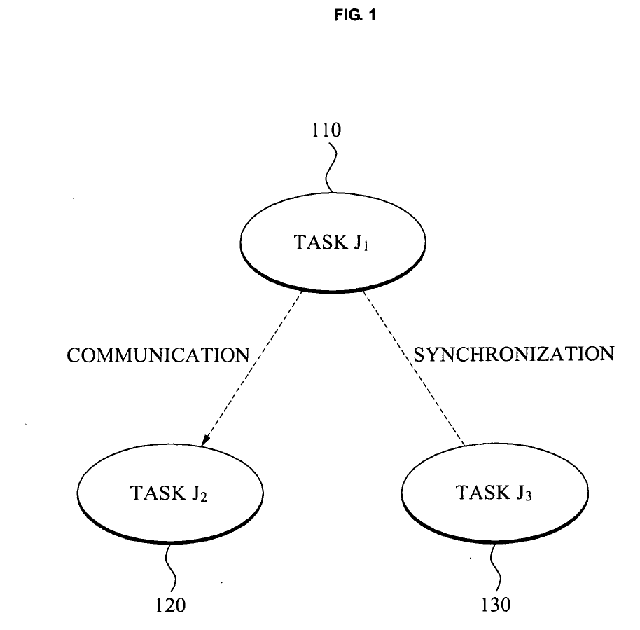

FIG. 1 illustrates tasks according to example embodiments. Referring to FIG. 1, a task J₁ and a task J₂ respectively have a communication-related operation type (communication type), and the task J₁ and a task J₃ respectively have a synchronization-related operation type (synchronization type).

Although not shown in FIG. 1, the tasks may be a ‘predecessor/successor type,’ in which running of any one task is completed before running of another task starts. Also, operation types being obtainable by the tasks may include a ‘computing type’ in which the tasks separately perform a computing operation without involving any communication and synchronization.

As for the synchronization type, the tasks having the synchronization type may have a relation synchronized with respect to a critical section. A policy of managing/controlling tasks accessing the critical section may be considered as a synchronization policy. Specifically, when more than one task among the tasks wants to access the critical section, only one task is chosen and allowed to run in the critical section and other tasks are blocked until the chosen task exits from the critical section by the synchronization policy.

Also, tasks having the communication type may mutually transmit/receive data. In this instance, an arrow illustrated between the task J₁ and the task J₂ may designate a moving direction of data. For example, the task J₂ receives data while the task J₁ transmits data, and conversely, the task J₁ may receive data while the task J₂ transmits data.

Also, as for the computing type, tasks having the computing type may independently perform a computing operation in a specific time duration and neither transmit/receive data nor access any critical section.

Consequently, it can be found that tasks may be operated according to operation types different from each other with time. In particular, tasks may have one of the synchronization type, communication type, and computing type with respect to a particular time.

In this instance, a system of estimating multi-tasking performance according to example embodiments may analyze operations of tasks with respect to time, and may divide the operations of the tasks in accordance with predefined operation types. Also, the system may divide a plurality of tasks into a plurality of sub tasks based on the predefined operation types.

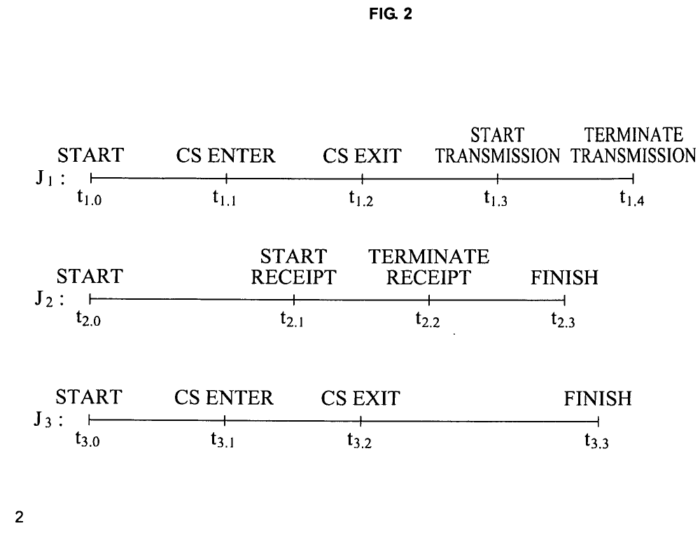

FIG. 2 illustrates an example of operation types depending on times of the tasks illustrated in FIG. 1.

Referring to FIG. 2, operations depending on a time of the task J₁ may be divided into four time sections. Specifically, the task J₁ may start its running at a time of t_{1.0}, and may exist in a critical section between t_{1.1} and a time t_{1.2}. Also, the task J₁ transmits data to the task J₂ between t_{1.3} and t_{1.4}.

Operations of the tasks J₂ and J₃ may be respectively divided into three time sections according to the same principle as described above.

In this instance, the system of estimating multi-tasking performance according to example embodiments may divide the tasks J₁, J₂, and J₃ into a plurality of sub tasks in accordance with predefined operation types. Specifically, the task J₁ may be divided into four sub tasks, and the tasks J₂ and J₃ may be divided into three sub tasks, respectively.

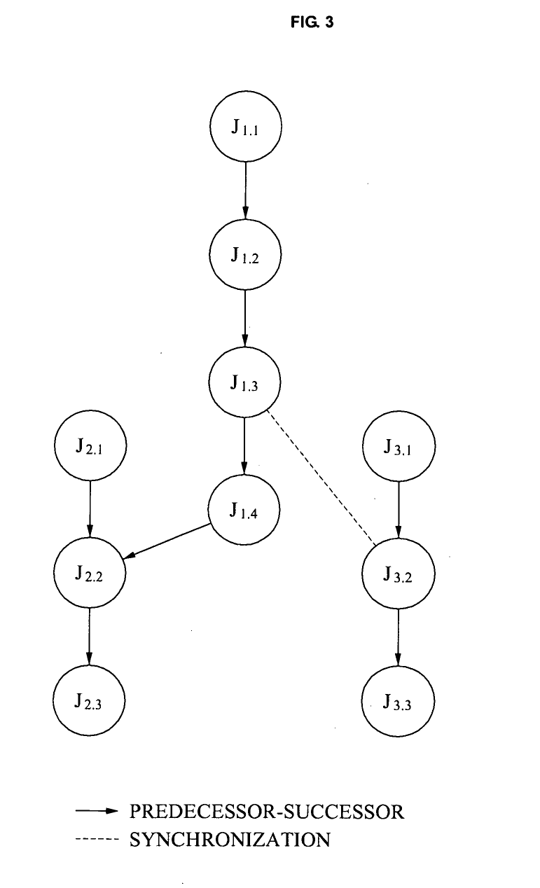

FIG. 3 illustrates an example of sub tasks divided and arranged from the tasks illustrated in FIG. 1.

Referring to FIG. 3, a plurality of sub tasks may be separated from each of the tasks J₁, J₂, and J₃. Sub tasks of J_{1.1}, J_{1.2}, J_{1.3}, and J_{1.4} may be separated from the task J₁, and sub tasks of J_{2.1}, J_{2.2}, and J_{2.3} may be separated from the task J₂. Also, sub tasks of J_{3.1}, J_{3.2}, and J_{3.3} may be separated from the task J₃.

Specifically, J_{1.1}, J_{1.2}, J_{1.3}, and J_{1.4} may be sub tasks of J₁ in each time section of t_{1.0} to t_{1.1}, t_{1.1} to t_{1.2}, t_{1.2} to t_{1.3}, and t_{1.3} to t_{1.4}. Also, similarly, J_{2.1}, J_{2.2}, J_{2.3} and J_{3.1}, J_{3.2}, J_{3.3} are sub tasks in accordance with the operation types of each of the tasks J₂ and J₃.

The system according to example embodiments may arrange the plurality of sub tasks in accordance with a predecessor-successor structure. Accordingly, the plurality of sub tasks may be arranged in accordance with a running order. For example, J_{1.2} may be a sub task which may be a predecessor with respect to J_{1.1} and may be a successor with respect to J_{1.3}.

Consequently, the system according to example embodiments including the communication type and calculation type may convert and arrange tasks having a variety of operation types into a plurality of sub tasks, thereby simply arranging a running order of the plurality of sub tasks.

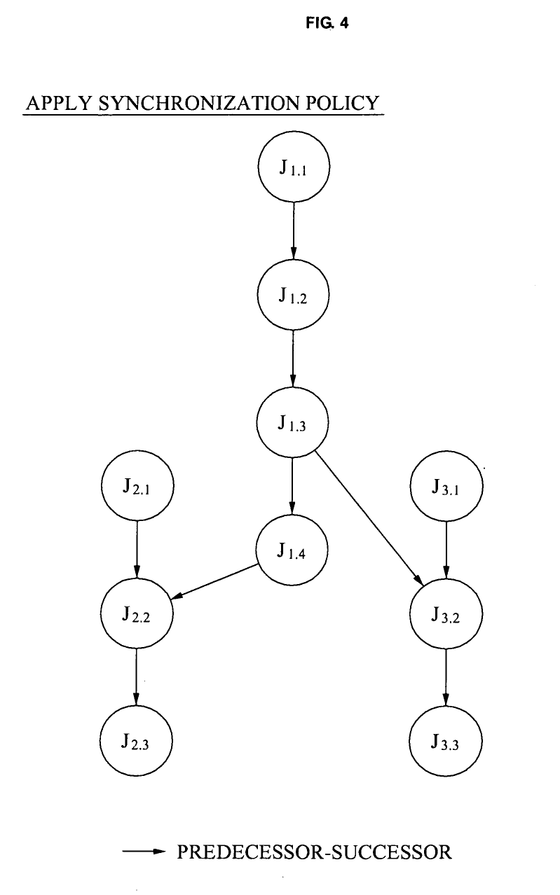

FIG. 4 illustrates another example of sub tasks arranged in accordance with a predecessor-successor structure of the present disclosure.

Referring to FIG. 4, the system of estimating multi-tasking performance according to example embodiments may apply the scheduling policy (not shown) and synchronization policy to sub tasks, and thus may more simply arrange the running order of the sub tasks.

The scheduling policy may be a concept including a policy of distributing sub tasks capable of being presently run to processors and may be a policy of selecting sub tasks capable of being immediately run in each of the processors. The system according to example embodiments may apply a variety of scheduling policies to the sub tasks, and may appropriately select sub tasks corresponding to each of the processors, so that the system may be used for estimating multi-tasking performance.

Here, the scheduling policies may include priority based-policies, such as rate monotonic (RM) or earliest deadline first (EDF), for example, and may include proportionate based-policies to allow a running operation only for a quantum of a specific time, such as round-robin (RR) or Pfair, for example. The system according to example embodiments may apply a variety of scheduling policies to the sub tasks without changing main parts of the algorithm of estimating multi-tasking performance.

Also, the synchronization policy may denote a policy of controlling entrance of at least two sub tasks into the critical section or exit therefrom, and may include adjusting priority of the sub tasks as necessary.

The system according to example embodiments may apply the synchronization policy to sub tasks J_{1.3} and J_{3.2} having the synchronization type. When sub task J_{1.3} is chosen to enter into the critical section, J_{1.3} and J_{3.2} may be simply arranged in accordance with a predecessor-successor structure as if J_{1.3} is a predecessor and J_{3.2} is a successor. Similarly, when sub task J_{3.2} is chosen to enter into the critical section, J_{3.2} and J_{1.3} may be simply arranged in accordance with a predecessor-successor structure as if J_{3.2} is a predecessor and J_{1.3} is a successor. Additionally, for example, task J_{1.4} may be a predecessor to task J_{2.2}. Consequently, the system according to example embodiments may simply arrange the sub tasks in accordance to the predecessor-successor structure without being restricted by the operation types of the sub tasks.

Accordingly, the system according to example embodiments may estimate multi-tasking performance by simply simulating predecessor-successor relations without simulating entrance of the sub tasks having the synchronization type into the critical section or exit therefrom, and thus may reduce a required calculation quantity.

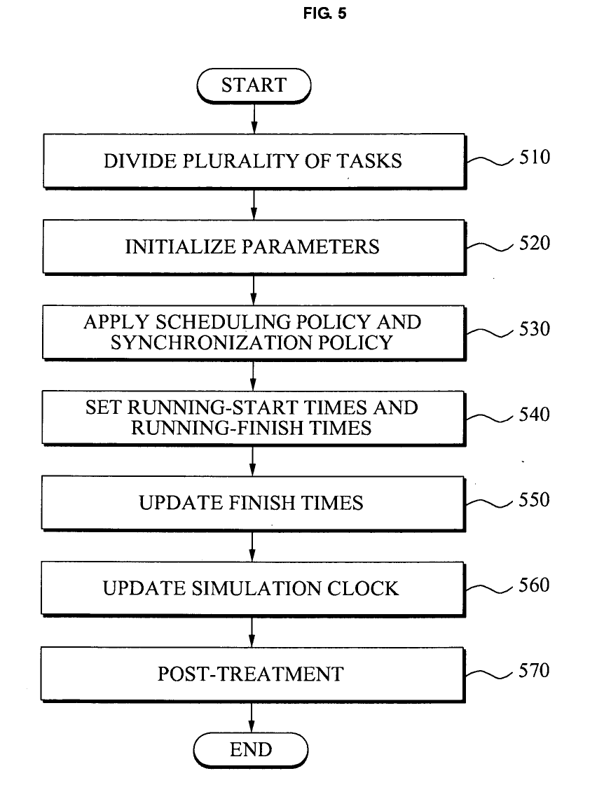

FIG. 5 is a flowchart illustrating a method of estimating multi-tasking performance according to example embodiments.

Prior to specifically describing the method of estimating multi-tasking performance, it may be assumed that a release time when a task Jᵢ is capable of being run denotes Rᵢ, an entire running period of the task Jᵢ denotes Tᵢ, and an entire deadline denotes Dᵢ.

Also, the method according to example embodiments may use a separate simulation clock in order to estimate a running-finish time of tasks, and calculate a running-start time and running-finish time of each of the sub tasks while gradually increasing the simulation clock. In this instance, the simulation clock is assumed to increase only in a time requiring scheduling.

Referring to FIG. 5, in operation 510, the method according to example embodiments divides a plurality of tasks into a plurality of sub tasks in accordance with a predefined operation type.

Accordingly, a task Jᵢ may be divided into a plurality of sub tasks of J_{i,1}, J_{i,2}, J_{i,3}, . . . , and J_{i,j}.

In this instance, the predefined operation types may include at least one of a computing type, a synchronization type, and a communication type, and each of the plurality of sub tasks J_{i,1}, J_{i,2}, J_{i,3}, . . . , and J_{i,j} may have a unique operation type.

Also, in operation 520, the method according to example embodiments may initialize at least one state parameter indicating an operation state of the plurality of sub tasks or at least one time parameter required to estimate a running time of the plurality of sub tasks.

In order to estimate multi-tasking performance, the state parameter or the time parameter may be used. The state parameter may denote an operation state of the sub tasks. In this instance, the operation state may include a non-ready state in which a running operation may not currently be performed, a ready state in which the running operation may currently be performed, a running state in which the running operation may currently be performed, a blocked state of a stand-by state while not entering into the critical section even though it is desired to enter during performing the running operation, and a finished state in which the running operation may be finished.

Also, the time parameter includes a period, a deadline, a running-start time, a running-finish time, a required running time, and a release time of a sub task.

In this instance, the method may initialize a period T_{i,j}, a deadline D_{i,j}, a running-start time S_{i,j}, a running-finish time F_{i,j}, a running time E_{i,j}, a release time R_{i,j}, a priority P_{i,j}, and a state_{i,j} of a sub task J_{i,j}.

The period T_{i,j} and deadline D_{i,j} of the sub task J_{i,j} may be set to have the same values as the period Tᵢ and the deadline Dᵢ of a task Jᵢ, and the running-start time S_{i,j}, the running-finish time F_{i,j}, and the priority P_{i,j} of the sub task J_{i,j} may be set to be undefined.

A required running time E_{i,j} of the sub task J_{i,j} may be estimated based on a release time, an entrance time into the critical section and an exit time therefrom, a transmission-start time and transmission-finish time of data, and a final-finish time of the task Jᵢ.

The release times R_{i,j} of the sub tasks J_{i,j} may be determined by the following method. When a release time Rᵢ of the task Jᵢ is pre-determined, a release time R_{i,1} of a first sub task J_{i,1} may be determined to be the same as the release time Rᵢ, and the release times R_{i,j} of the remaining sub tasks may be determined to be undefined. Also, when the release time Rᵢ of the task Jᵢ is not determined, all release times of sub tasks of the task Jᵢ may be determined to be undefined. When release times are undefined, release times of the sub tasks may be determined based on the predecessor-successor structure while estimating multi-tasking performance in accordance with the following process.

Specifically, when a running-finish time F_{i,j-1} of a sub task J_{i,j-1} is finally determined, the release time R_{i,j} of the sub task J_{i,j} may be determined to have the same value as F_{i,j-1}. Also, in a case where a task Jₙ and a task Jₘ have ‘predecessor/successor type’ or the communication type, a running-finish time F_{n,x} of a final sub task J_{n,x} of Jₙ may be finally determined, and a release time R_{m,1} of a first sub task J_{m,1} of Jₘ may be determined to have the same value as F_{n,x}.

When all release times of the sub tasks are initialized, a value of the simulation clock may be set as a minimum value from among values of the determined release times. Then, when the value of the simulation clock is determined, states of sub tasks having the same release time as a value of a current clock may be displayed as ‘ready state’, and states of the remaining sub tasks may be displayed as ‘non-ready state’.

Also, when parameters of the sub tasks are initialized, an initialization in a type and number of processors, an initialization in quantum (in a case of using the quantum-based scheduling policy such as round-robin or Pfair, a time unit of a processor assigned to execute tasks is received and an initialization is performed), an initialization in a simulation-finish time, etc., may be performed.

Also, in operation 530, the method of estimating multi-tasking performance according to example embodiments may apply the scheduling policy and the synchronization policy to the plurality of sub tasks in accordance with the predecessor-successor structure.

The method according to example embodiments may apply the scheduling policy and the synchronization policy while gradually increasing the values of the simulation clock. When a current value of the simulation clock is ‘clock’, the scheduling policy may be applied to the sub tasks being in ‘ready state’.

As described above, the scheduling policy may include a policy of distributing, to processors, sub tasks in ‘ready state’ capable of being presently run, and a policy of selecting sub tasks capable of being immediately run in each of the processors.

In this instance, a state of the sub task selected in each of the processors is changed into ‘running state’. When an operation state in the value of the preceding simulation clock is ‘running state’, and an operation state in the value of the current simulation clock may be changed to ‘ready state’, and a value of clock_preempt_{i,j} of the corresponding sub task J_{i,j} may be set as the value of the current simulation clock. This is for the purpose of accurately calculating a time delay occurring due to preempting in a case where the running-finish time of the sub task J_{i,j} is updated in operation 550.

Also, the method according to example embodiments may apply the synchronization policy to sub tasks having an operation type of the synchronization type from among sub tasks having an operation state of ‘running state’ in the current clock.

When a specific sub task is determined to be continuously run, a predecessor-successor relation may be set between the specific sub task and another sub task desiring to enter into the critical section for the sub task. This is because, in a case of the sub tasks having the synchronization type, operation states of the remaining sub tasks may not be changed into ‘ready state’ until a running of a sub task previously entering into the critical section is finished.

In this instance, a sub task having an operation state of ‘running state’ may not enter into the critical section, and the operation state may be changed into ‘blocked state’. Then, the scheduling policy may be applied again to the sub task. In this case, since the sub task is in a state not capable of being run, a suitable sub task from among other sub tasks having the operation state of ‘ready state’ may be required to be selected.

For reference, the synchronization policy being applicable in example embodiments may include a priority inheritance protocol (PIP), a priority ceiling protocol (PCP), a stack resource policy (SRP), a multiprocessor priority ceiling protocol (MPCP), a multiprocessor stack resource policy (MSRP), etc.

Also, in operation 540, the method according to example embodiments may set a running-start time and running-finish time of a sub task in order to estimate multi-tasking performance of the plurality of tasks using the arranged plurality of sub tasks.

A running-start time S_{i,j} and running-finish time F_{i,j} of a sub task J_{i,j} having an operation state of ‘running state’ may be calculated with respect to each of the processors. In this instance, when S_{i,j} of the sub task is previously calculated, operation 540 may be omitted. Otherwise, S_{i,j} may be set as a value of the current simulation clock, and F_{i,j} may be set as a sum of a value of clockₖ and a required running time E_{i,j} (S_{i,j}=clock, F_{i,j}=clock+E_{i,j}). Here, the required running time E_{i,j} may be previously estimated as described above.

Also, in operation 550, the method according to example embodiments may update the set running-finish time based on a preempted time generated due to preempting of another sub task, with respect to the plurality of sub tasks.

Specifically, sub tasks having a value of clock_preempt_{i,j} different from ‘0’ from among sub tasks whose current operation state is ‘running state’ may be ascertained. Then, as for the ascertained sub tasks, a time elapsed since a time previously preempted by another sub tasks until the current time may be added to the running-finish time (F_{i,j}=F_{i,j}+(clock−clock_preempt_{i,j})). Also, min_f of a minimum value from among the updated running-finish times may be calculated.

Also, in operation 560, the method according to example embodiments may update the simulation clock.

In particular, the method according to example embodiments searches the next event existing at the nearest time from the current time, and may update the simulation clock to a generated time of the next event. In this instance, events such as ‘finish of the sub task’, ‘release of a new sub task’, ‘termination of quantum’, etc., may be retrieved as the next event.

More specifically, min (R_{a,b}) of a minimum value from among release times of the sub tasks or a minimum value of a quantum termination time t_{q} and min_f may be selected, and the simulation clock may be updated based on the selected value (clock=min{min_f, min(R_{a,b}), t_{q}}).

Also, in operation 570, the method according to example embodiments may perform post-treatment.

When the running-start time and running-finish time of all sub tasks are finally determined, the multi-tasking performance may be estimated in accordance with the determined running-start time and running-finish time. Otherwise, a multi-tasking performance estimation algorithm according to example embodiments may be applied to the remaining sub tasks.

Specifically, when the simulation clock is updated as a running-finish time of a sub task, an operation state of the sub task may be changed into ‘finish state’, and a running-finish time finally updated may be decided. Finally, operation states of successors of the finished sub task may be changed into ‘ready state’, and operation 520 may be re-performed (not shown).

Also, although not shown in FIG. 5, the method according to exemplary embodiments may further include determining whether to load or run the plurality of tasks depending on the estimated multi-tasking performance.

Specifically, the method according to example embodiments may not load or run the plurality of tasks when the estimated multi-tasking performance is inferior to a predetermined reference level. Conversely, the method according to example embodiments may load or run the plurality of tasks when the estimated multi-tasking performance is identical to or superior to the predetermined reference level.

Also, although not shown in FIG. 5, the method according to example embodiments may further include deciding a running policy of running the plurality of tasks, or a resource allocation policy based on the estimated multi-tasking performance. Here, the running policy and the resource allocation policy may be concepts including both of the scheduling policy and the synchronization policy. Accordingly, the method according to example embodiments may decide an optimized scheduling policy or synchronization policy.

The method of estimating multi-tasking performance according to the described example embodiments may be recorded in computer-readable media including program instructions to implement various operations embodied by a computer. The media may also include, alone or in combination with the program instructions, data files, data structures, and the like. Examples of computer-readable media include recording and/or storage media, for example, magnetic media such as hard disks, floppy disks, and magnetic tape; optical media such as CD ROM disks, DVD disks and Blu Ray disks; magneto-optical media such as optical disks; and hardware devices that are specially configured to store and perform program instructions, such as read-only memory (ROM), random access memory (RAM), flash memory, etc. The media may also be transmitted over a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described example embodiments.

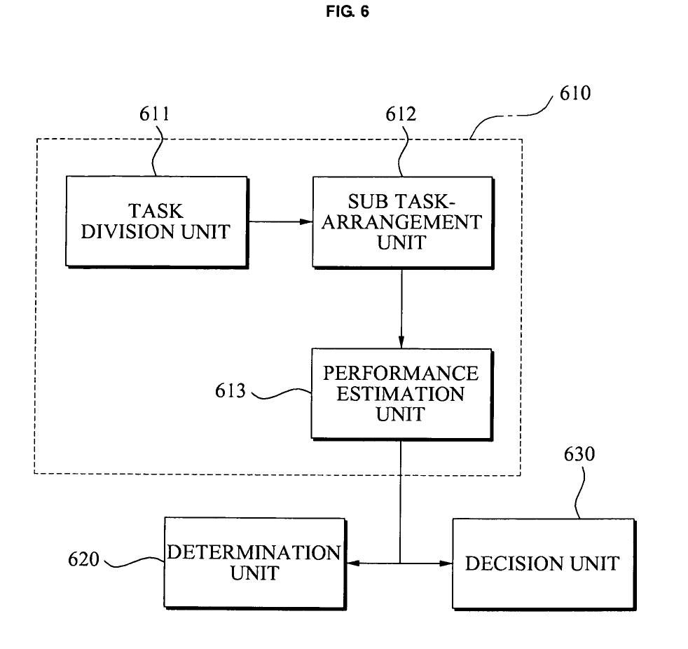

FIG. 6 is a block diagram illustrating a system 610 of estimating multi-tasking performance according to example embodiments, and units using results of the system.

Referring to FIG. 6, the system 610 may include a task division unit 611, a sub task-arrangement unit 612, and a performance estimation unit 613.

The task division unit 611 may divide a plurality of tasks into a plurality of sub tasks in accordance with predefined operation types. Here, the predefined operation types may include at least one of calculation type, synchronization type, and communication type.

Also, the sub task-arrangement unit 612 may arrange the plurality of sub tasks in accordance with a predecessor-successor structure based on the operation types of the plurality of sub tasks.

In this instance, the sub task-arrangement unit 612 may apply the synchronization policy or the scheduling policy to the plurality of sub tasks, and arrange the plurality of sub tasks in accordance with the predecessor-successor structure.

Also, the performance estimation unit 613 may estimate multi-tasking performance of the plurality of tasks using the arranged plurality of sub tasks.

In this instance, although not shown in FIG. 6, the performance estimation unit 613 may include a finish time setting unit to set a running-finish time of the plurality of sub tasks based on a running-start time of the plurality of sub tasks and a pre-estimated required running time, and a running time-estimation unit to estimate a running time of the plurality of sub tasks using the running-start time and the set running-finish time. Also, the running time-estimation unit may update the set running-finish time based on a preempted time generated due to preempting of another sub task with respect to the plurality of sub tasks, and may estimate the running time of the plurality of sub tasks based on the updated running-finish time.

The multi-tasking performance estimated by the system 610 may be diversely utilized. In particular, a determination unit 620 may determine whether the plurality of tasks are loaded or run in accordance with the estimated multi-tasking performance. Also, a decision unit 630 may decide a running policy of running the plurality of tasks or a resource distribution policy based on the estimated multi-tasking performance.

Capabilities which are not described although shown in FIG. 6 would be definitely appreciated from features described in FIGS. 1 to 5, and thus will be herein omitted.

As described above, according to example embodiments, there are provided a method and system of estimating multi-tasking performance which may divide a plurality of tasks into a plurality of sub tasks, and may arrange the plurality of sub tasks in accordance with a predecessor-successor structure, thereby effectively estimating the multi-tasking performance even in a case where the plurality of tasks have various synchronization policies or scheduling policies.

According to example embodiments, there are provided a method and system of estimating multi-tasking performance which may update a running-finish time based on a preempted time of another sub task to estimate the multi-tasking performance, thereby reducing a calculation amount to estimate the multi-tasking performance.

Although a few embodiments have been shown and described, it would be appreciated by those skilled in the art that changes may be made in these embodiments without departing from the principles and spirit of the disclosure, the scope of which is defined in the claims and their equivalents.

What is claimed is:

1. A method of estimating multi-tasking performance, the method comprising:
dividing a plurality of tasks into a plurality of sub tasks in accordance with predefined operation types;
arranging the plurality of sub tasks in accordance with a predecessor-successor structure based on the operation types of the plurality of sub tasks; and
estimating multi-tasking performance of the plurality of tasks using the arranged plurality of sub tasks.

2. The method of claim 1, wherein the estimating of the multi-tasking performance includes:
setting a running-finish time of the plurality of sub tasks based on a running-start time of the plurality of sub tasks and a pre-estimated required running time; and
estimating an eventual running-finish time of the plurality of sub tasks using the running-start time and the set running-finish time.

3. The method of claim 2, wherein the estimating of the eventual running-finish time updates the set running-finish time based on a preempted time generated due to preempting of another sub task with respect to the plurality of sub tasks, and estimates the eventual running-finish time of the plurality of sub tasks based on the updating.

4. The method of claim 1, wherein the arranging applies a synchronization policy or a scheduling policy to the plurality of sub tasks, and arranges the plurality of sub tasks in accordance with the predecessor-successor structure and the synchronization policy or the scheduling policy.

5. The method of claim 1, wherein the predefined operation types include at least one of a computing type, a synchronization type, and a communication type, and the arranging arranges at least two sub tasks having the communication type in accordance with the predecessor-successor structure and arranges at least two sub tasks having the synchronization type in accordance with the predecessor-successor structure based on a synchronization policy.

6. The method of claim 1, wherein the predefined operation types include at least one of a computing type, a synchronization type, and a communication type.

7. The method of claim 6, wherein at least two tasks having the synchronization type from among the plurality of tasks are synchronized with respect to a critical section, and at least two tasks having the communication type from among the plurality of tasks transmit/receive data with each other.

8. The method of claim 1, wherein the dividing includes initializing at least one state parameter indicating an operation state of the plurality of sub tasks or at least one time parameter required to estimate a running time of the plurality of sub tasks, and the estimating of the multi-tasking performance estimates the multi-tasking performance of the plurality of tasks using the at least one state parameter or the at least one time parameter.

9. The method of claim 1, further comprising:
determining whether the plurality of tasks are loaded or run in accordance with the estimated multi-tasking performance.

10. The method of claim 1, further comprising:
deciding a running policy of running the plurality of tasks, or a resource allocation policy based on the estimated multi-tasking performance.

11. A system of estimating multi-tasking performance, the system comprising:
a task division unit dividing a plurality of tasks into a plurality of sub tasks in accordance with predefined operation types;
a sub task-arrangement unit arranging the plurality of sub tasks in accordance with a predecessor-successor structure based on the operation types of the plurality of sub tasks; and
a performance estimation unit estimating multi-tasking performance of the plurality of tasks using the arranged plurality of sub tasks.

12. The system of claim 11, wherein the performance estimation unit includes:
a finish time setting unit setting a running-finish time of the plurality of sub tasks based on a running-start time of the plurality of sub tasks and a pre-estimated required running time; and
a running-finish time estimation unit estimating an eventual running-finish time of the plurality of sub tasks using the running-start time and the set running-finish time.

13. The system of claim 12, wherein the running-finish time estimation unit updates the set running-finish time based on a preempted time generated due to preempting of another sub task with respect to the plurality of sub tasks, and estimates the eventual running-finish time of the plurality of sub tasks based on the updated running-finish time.

14. The system of claim 11, wherein the sub task arrangement unit applies a synchronization policy or a scheduling policy to the plurality of sub tasks, and arranges the plurality of sub tasks in accordance with the predecessor-successor structure and the synchronization policy or the scheduling policy.

15. The system of claim 11, wherein the task division unit includes an initialization unit initializing at least one state parameter indicating an operation state of the plurality of sub tasks, or at least one time parameter required to estimate a running time of the plurality of sub tasks, and the performance estimation unit estimates the multi-tasking performance of the plurality of tasks using the at least one state parameter or the at least one time parameter.

16. The system of claim 11, further comprising:
a determination unit determining whether the plurality of tasks are loaded or run in accordance with the estimated multi-tasking performance.

17. The system of claim 11, further comprising:
a decision unit deciding a running policy of running the plurality of tasks or a resource distribution policy based on the estimated multi-tasking performance.

18. A computer-readable recording medium storing a program to cause a computer to implement the method of claim 1.
